(19) United States
(12) Patent Application Publication
(10) Pub. No.: US 2012/0051564 A1
(43) Pub. Date: Mar. 1, 2012

(54) FLAT SPEAKER STRUCTURE AND MANUFACTURING METHOD THEREOF

(75) Inventors: Chang-Ho Liou, Changhua County (TW); Ming-Daw Chen, Hsinchu City (TW); Kuo-Hua Tseng, New Taipei City (TW); Kuan-Wei Chen, Taichung City (TW); Che-Yuan Sun, Hualien County (TW)

(73) Assignee: INDUSTRIAL TECHNOLOGY RESEARCH INSTITUTE, Hsinchu (TW)

(21) Appl. No.: 13/221,934

(22) Filed: Aug. 31, 2011

Related U.S. Application Data
(60) Provisional application No. 61/378,392, filed on Aug. 31, 2010.

(30) Foreign Application Priority Data
Aug. 29, 2011 (TW) 100130918

(51) Int. Cl. H04R 19/01; H04R 31/00

(52) U.S. Cl. 381/191; 427/154; 427/58

(57) ABSTRACT

A reliable flat speaker structure and a manufacturing method thereof are introduced herein. The flat speaker structure includes a first and a second vapor-resistant structure and a flat speaker unit structure. The first and second vapor-resistant structures are respectively disposed on an outer side of the flat speaker structure or an outer side of the vibrating membrane, by which the vapor in the environment is prevented from entering the inner space of the flat speaker structure. The flat speaker unit structure at least includes a first porous electrode, an electret layer with a metal film, and a second porous electrode. Signal sources in an AC form may be applied to the first and second porous electrodes and/or the metal film of the electret layer and respective sounds are generated from the flat speaker structure by attractive or repulsive forces between the porous electrodes and the electret layer.

### CROSS-REFERENCE TO RELATED APPLICATION

This application claims the priority benefits of U.S. provisional application Ser. No. 61/378,392, filed on Aug. 31, 2010 and Taiwan application serial no. 100130918, filed on Aug. 29, 2011. The entirety of each of the above-mentioned patent applications is hereby incorporated by reference herein and made a part of this specification.

### BACKGROUND

### Technical Field

The disclosure relates to a flat speaker structure and a manufacturing method thereof.

Vision and audition are two most direct sensory responses of human beings. Thus, scientists have been dedicated to developing various renewable vision and audition related systems. A moving coil speaker is still the major product in the market among all the existing renewable speakers. However, along with people's increasing demand to high quality sensory enjoyment and the ever-decreasing sizes of 3C products (computer, communication, and consumer electronics), speakers which have low power consumption, light weights, and small sizes and are designed according to human engineering are can be used in large flat speakers or small walkman headphones and stereo mobile phones, and such technology may be broadly applied in the near future.

Presently, electroacoustic speakers are mainly categorized into direct and indirect speakers according to their radiation patterns, and the speakers are approximately grouped into moving coil speakers, piezoelectric speakers, and electrostatic speakers according to the driving methods thereof. The moving coil speaker is currently the most commonly used and most mature product. However, the moving coil speaker cannot be compressed due to its physical structure defect. Accordingly, the moving coil speaker is not suitable for 3C products and home entertainment systems that are required to be flattened.

A piezoelectric speaker pushes a membrane to produce sounds based on the piezoelectric effect of a piezoelectric material (i.e., the material is deformed when an electric field is supplied thereon). Such a piezoelectric speaker has a compressed and small structure. An electrostatic speaker is a hi-end earphone or speaker in the current market. According to the operation principle of a conventional electrostatic speaker, a conductive membrane is clamped between two fixed porous electrode plates to form a capacitor. An electric field is generated by supplying a DC bias to the membrane and an AC voltage to the two fixed porous electrode plates. The conductive membrane is driven by the electrostatic force generated by the positive and negative electric fields to vibrate, so as to produce sound.

The conventional electrostatic speaker requires a DC bias of up to hundreds or even thousands voltages, and accordingly a pricey and bulky amplifier has to be connected to the conventional electrostatic speaker, which results in the unpopularity of the electrostatic speaker.

U.S. Pat. No. 3,894,199 discloses an electrostatic speaker in which a conductive vibrating membrane is clamped by two fixed porous electrode plates to form a capacitor. By supplying a direct current (DC) bias to the vibrating membrane and supplying an alternating current (AC) voltage of audio frequencies to the two fixed electrodes, the conductive vibrating membrane is vibrated due to an electrostatic force generated under a positive and a negative electric fields, so as to radiate sound. The bias of the conventional electrostatic speaker is as high as hundreds to thousands of volts, such that expensive and bulky amplifiers need to be externally connected.

Audio is a major element in the future applications of flexible electronics. However, the flexible electronics need have the characteristics of softness, thinness, low driving voltage, and high flexibility. Thus, how to break through the conventional design to fabricate elements having the characteristics required by the flexible electronics has become a major subject.

### SUMMARY

The disclosure provides according to one of the exemplary embodiments, a flat speaker structure that includes a vapor-resistant structure and a speaker unit. The speaker unit includes a porous electrode and an electret material. The porous electrode is made of metal or a conductive material, and the electret material includes a metal film or a conductive material layer and serves as a vibrating membrane. The vapor-resistant structure is located at an outer side of the flat speaker structure or an outer side of the vibrating membrane to prevent the environmental vapor from entering the speaker unit, so as to improve the reliability of the operation of the speaker unit. When signal sources in an AC form are applied to the porous electrode and the metal film or the conductive material layer of the vibrating membrane in the speaker unit, upper and lower electric fields are generated, such that sound is correspondingly generated from the speaker unit by attractive or repulsive forces between the porous electrode and the electret material that serves as the vibrating membrane.

According to one of the exemplary embodiments, the vapor-resistant structure includes a vapor-resistant protection layer and a plurality of insulation supporting members, and the insulation supporting members are located between the speaker unit and the vapor-resistant protection layer.

According to one of the exemplary embodiments, the vapor-resistant structure includes a vapor-resistant protection layer located on two sides of the vibrating membrane and also located in a plurality of pores of the porous electrode, and the two sides face the porous electrode of the speaker unit.

According to one of the exemplary embodiments, the vapor-resistant structure includes a vapor-resistant protection layer that is located on one side of the porous electrode of the speaker unit opposite to the other side of the porous electrode facing the vibrating membrane and also located in a plurality of pores of the porous electrode.

According to one of the exemplary embodiments, the vapor-resistant structure includes a vapor-resistant protection layer that is located on one side of the porous electrode of the speaker unit facing the vibrating membrane and also located in a plurality of pores of the porous electrode.

According to one of the exemplary embodiments, the vapor-resistant structure includes a first vapor-resistant protection layer and a second vapor-resistant protection layer that are respectively located on two sides of the vibrating membrane, and one of the two sides faces the porous electrode.

The disclosure further provides a manufacturing method of a vapor-resistant structure suitable for a flat speaker unit.

According to one of the exemplary embodiments, the manufacturing method includes forming a sacrificial layer on a substrate. A protection layer is formed above the sacrificial layer. A material of the protection layer is characterized by vapor resistance. A spacer layer is formed above the protection layer, and the spacer layer defines an area occupied by the vapor-resistant structure. The protection layer and the spacer layer above the protection layer are peeled off from the sacrificial layer. A plurality of insulation supporting members are configured above the protection layer within an area occupied by the spacer layer, so as to form a pattern of the insulation supporting members in the area occupied by the spacer layer.

According to one of the exemplary embodiments, the manufacturing method of the vapor-resistant structure includes forming a vapor-resistant protection layer that is located on one side of a porous electrode of a speaker unit opposite to the other side of the porous electrode facing a vibrating membrane.

According to one of the exemplary embodiments, the manufacturing method of the vapor-resistant structure includes forming a vapor-resistant protection layer that is located on one side of a porous electrode of a speaker unit facing a vibrating membrane and also located in a plurality of pores of the porous electrode.

According to one of the exemplary embodiments, the manufacturing method of the vapor-resistant structure includes forming a first vapor-resistant protection layer and a second vapor-resistant protection layer that are respectively located on two sides of a vibrating membrane, and one of the two sides faces a porous electrode.

According to one of the exemplary embodiments, the manufacturing method of the vapor-resistant structure includes forming a vapor-resistant protection layer located on two sides of the vibrating membrane and also located in a plurality of pores of the porous electrode, and the two sides face the porous electrode of the speaker unit.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic cross-sectional view illustrating a flat speaker structure according to one of a plurality of exemplary embodiments of the disclosure.

FIG. 2A is a schematic cross-sectional view illustrating a flat speaker unit according to one of the exemplary embodiments of the disclosure.

FIG. 2B is a schematic cross-sectional view illustrating a flat speaker structure according to one of the exemplary embodiments of the disclosure.

FIG. 2C is a schematic cross-sectional view illustrating a flat speaker unit according to one of the exemplary embodiments of the disclosure.

FIG. 2D is a schematic cross-sectional view illustrating a flat speaker structure according to one of the exemplary embodiments of the disclosure.

FIG. 3A to FIG. 3G are schematic cross-sectional views illustrating a manufacturing process of a vapor-resistant structure according to an exemplary embodiment of the disclosure.

FIG. 4A is a schematic cross-sectional view illustrating a flat speaker structure according to one of the exemplary embodiments of the disclosure.

FIG. 4B is a schematic cross-sectional view illustrating a flat speaker structure according to another one of the exemplary embodiments of the disclosure.

FIG. 5A to FIG. 5E are schematic cross-sectional views illustrating flat speaker structures respectively having different reliable vapor-resistant structures according to some of the exemplary embodiments of the disclosure.

### DETAILED DESCRIPTION OF DISCLOSED EMBODIMENTS

One of the exemplary embodiments provides a flat speaker structure in which a vibrating membrane is made of a super-thin electret material, such that the flat speaker can replace the conventional electrostatic speaker that requires a bias as high as hundreds to thousands of volts. The flat speaker described in this disclosure has a simple structure and can be mass-produced according to existing techniques and fabrication processes. In one of the exemplary embodiments, a vapor-resistant structure for extending the life time of the flat speaker unit is provided, and thus the vapor-resistant structure is expected to be indispensable to the flexible speaker structure.

In one of the exemplary embodiments, a highly reliable flat speaker structure includes a vapor-resistant protection layer and a speaker unit. The speaker unit in one of the exemplary embodiments includes a porous electrode and an electret material. The porous electrode is made of metal or a conductive material, and the electret material includes a metal film or a conductive material layer and serves as a vibrating membrane. The vapor-resistant protection layer is located at the outer side of the flat speaker structure to prevent the environmental vapor from entering the speaker unit, so as to improve the reliability of the operation of the speaker unit. When signal sources in an AC form are applied to the porous electrode and the metal film or the conductive material layer of the vibrating membrane, upper and lower electric fields are generated, such that sound is correspondingly generated from the speaker unit by attractive or repulsive forces between the porous electrode and the electret material that serves as the vibrating membrane.

In one of the exemplary embodiments, a highly reliability flat speaker structure is provided, in which the flat speaker structure includes a first vapor-resistant protection layer, a second vapor-resistant protection layer, and a speaker unit. The speaker unit in one of the exemplary embodiments includes a first porous electrode, an electret material that serves as a vibrating membrane, and a second porous electrode. The first and second porous electrodes include metal or conductive materials, and the electret material includes a metal film or a conductive material layer. The first and second vapor-resistant protection layers are located at the outer side of the speaker unit to prevent the environmental vapor from entering the speaker unit, and thereby the reliability of the operation of the speaker unit can be improved. When signal sources in an AC form are applied to the first and second porous electrodes and the metal film or the conductive material layer of the vibrating membrane, upper and lower electric fields are generated, such that sound is correspondingly generated from the speaker unit by attractive or repulsive forces between the first and second porous electrodes and the electret material that includes a metal film.

### Electret Material

In the aforementioned speaker unit, based on the charge characteristics and an electrostatic effect of the electret material, when the electret vibrating membrane is stimulated by an external voltage, a surface of the vibrating membrane is deformed, so as to drive the air surrounding the vibrating membrane to generate sound. As known from the electrostatic force equation and energy laws, the force exerted on the vibrating membrane equals to the capacitance of the whole speaker multiplied by the intensity of the internal electric field and the externally-input sound voltage signal. The larger the force exerted on the electret vibrating membrane is, the louder the output sound is.

The speaker unit of this disclosure has a simple structure and can be mass-produced by applying existing techniques and fabrication processes, such that that fabrication costs thereof can be effectively reduced. In this exemplary embodiment, the reliability and the sound producing efficiency of the speaker can be improved. The speaker unit can be a flexible speaker unit with flexible and bendable characteristics. Certainly, materials that are not affected in a bent state should be utilized.

In this exemplary embodiment, due to the characteristics of the charges in the electret material and the electrostatic effects, after the electret vibrating membrane is stimulated by the external voltages, the deformation of the vibrating membrane perpendicular to the surface of the vibrating membrane may occur. Namely, if the four sides of the vibrating membrane are fixed, the deformation parallel to the surface of the vibrating membrane can be prevented, while the deformation perpendicular to the surface of the vibrating membrane occurs, so as to drive the air around the vibrating membrane to generate sound. As known from the electrostatic force formula and energy laws that, the force applied on the vibrating membrane equals to the capacitance value of the whole speaker multiplied by the intensity of the internal electric field and the externally-inputted sound voltage signal, and the larger the force applied on the vibrating membrane is, the louder the outputted sound is.

According to the Coulomb's Law, a product of charges of two charged objects is directly proportional to the electrostatic force interacted there-between, and inversely proportional to a square of the distance between the two objects. If the two charges are both positive or negative, the objects are repelled by repulsive electrostatic force. If one of the charges is positive, and the other is negative, the objects are attracted by an attractive electrostatic force. The electret material utilized in the flat speaker unit is an electro-sound actuator with an electret composite material including micro-pores or nano-pores. The flat speaker unit is formed by an electret vibrating membrane that is equidistantly or asymmetrically clamped by two charged porous electrode plates. The structure of the electro-sound actuator is similar to a capacitor device, and the two porous electrode plates are respectively applied with positive and negative charges from the signal source. According to the Coulomb's Law, an attractive force and a repulsive electrostatic force are simultaneously applied to the electret vibrating membrane in the middle, and the electrostatic force applied on a unit area of the vibrating membrane can be represented by a following equation (1).

$$p = \frac{2 {V}_{in} {V}_{e} {ɛ}_{0} ( \frac{1}{{S}_{a}} + \frac{{ɛ}_{e}}{{S}_{e}} ) {ɛ}_{e} {S}_{e}}{{( {S}_{e} + {ɛ}_{e} {S}_{a} )}^{2}} \qquad ( equation 1 )$$

Here, a vacuum permittivity ∈ₒ=8.85*10⁻¹² F/m, an electret dielectric constant is ∈ₑ, a thickness of the electret material is Sₑ, a thickness of an air layer is Sₐ, an input signal voltage is Vᵢₙ, a voltage of the electret material is Vₑ, and the electrostatic force applied to a unit area of the vibrating membrane is P. As known from the equation 1, the electrostatic force is directly proportional to the product of the bias and the audio signal voltage, and is inversely proportional to the distance between the porous electrode plates and the electret vibrating membrane. Therefore, if the electrostatic speaker can provide high ferroelectricity under the same distance, the required electrostatic force can be achieved with a relatively low audio AC voltage. In this exemplary embodiment, electret composite materials with micro-pores or nano-pores provide a ferroelectric amount of over hundreds to thousands of volts. According to the above electrostatic equation, the audio voltage can be reduced to a dozen of volts, so as to improve the practicality of the flat speaker of the exemplary embodiment.

According to the aforementioned theory, the electret vibrating membrane is forced by a push-pull electrostatic force under the effect of the positive and negative biases of the two porous electrode plates, such that the electret vibrating membrane vibrate to compress the surrounding air to output sound.

In this exemplary embodiment, the electret vibrating membrane may be an electret piezoelectric vibrating membrane which is formed by a dielectric material electrized (corona discharged) to be able to keep static charges for a long period of time, for instance. Moreover, the electret vibrating membrane may be a vibrating membrane formed by a single-layered dielectric material or multi-layered dielectric materials. Examples of this dielectric material include fluorinated hylenepropylene (FEP), polytetrafluoethylene (PTFE), polyvinylidene fluoride (PVDF), fluorine polymers, or other suitable materials. The dielectric material may include pores having diameters in micro-scale or nanometer-scale. Since the electret vibrating membrane is capable of maintaining the static charges for a long time after it is electrized, after corona charging, dipolar charges are generated in the material to generate the electrostatic effect.

Currently, the sound volume may not be increased by the sound-pressure of the speaker unit within a short period of time due to the materials or design factors, and improvements thereof are mostly directed to an increase in the ferroelectric amount of the electret vibrating membrane or enhancement of an acoustic structure design. However, the above methods require time-consuming studies and cannot fulfill the demand of the application design in increasing the sound volume within a short time. Therefore, a method of increasing the sound volume by improving the structural design of the speaker unit may help of this exemplary embodiment.

In another embodiment of the disclosure, the speaker units are integrated. Without changing the design of the input signal source, sound can be produced by driving a plurality of speaker units, so as to rapidly resolve the problem of material limitation, etc.

### Material of Electrode Layer

In the aforementioned highly reliable flat speaker structure, the speaker unit is flexible. Namely, the porous electrodes can be made of transparent polymer materials, such as polycarbonate (PC), polyethylene terephthalate (PET), cyclic olefin copolymer (COC), polymethyl methacrylate (PMMA), and so on; the first and second porous electrodes can be made of transparent materials, such as indium tin oxide (ITO), indium zinc oxide (IZO), or the like. If a material characterized by reflectivity is required, a metal reflection film (e.g., aluminum, silver, etc.) can be used.

In an exemplary embodiment, the porous electrodes of the speaker unit can include a single metal film having a conductive effect. In another exemplary embodiment, the first and the second porous electrodes can also include a porous layer and an electrode layer. The porous layer can be an insulation layer having no conductivity or a conductive layer characterized by conductivity. The electrode layer is a conductive layer that includes the conductive material.

If the transparency or reflectivity is not taken into consideration, when the porous layer is an insulation layer, the insulation layer can be made of non-conductive materials, such as plastic (PET, PC), rubber, paper, non-conductive cloth (cotton fiber, polymer fiber), and so on. The electrode layer can be made of a pure metal material (including aluminum, gold, silver and copper), an alloy thereof, or a dual-metal material of Ni/Au, one of ITO and IZO, a combination thereof, or a polymer conductive material PEDOT.

If the porous electrode of the speaker unit may be made of a single conductive material, the conductive material may be one of metal (iron, copper, aluminum, or an alloy thereof), conductive cloth (one of metal fiber, oxide metal fiber, carbon fiber, and graphite fiber), or a combination of different conductive materials.

### Supporting Members

According to one of the exemplary embodiments of the disclosure, in the design of the flat speaker unit, a plurality of supporting members may be configured between the porous electrode and the vibrating membrane. The supporting members may have various patterns and different heights based on actual requirements, so that the flat speaker unit can be configured on a region of the porous electrode. Here, the region of the porous electrode does not contain pores.

The supporting members in the flat speaker unit may be designed to have different arrangements and heights. When the structure of the supporting members is to be optimally designed, the arrangements and heights of the supporting members can be determined in consideration of an audio frequency. The supporting members may be dot-shaped, grid-shaped, cross-shaped, or can have a combination of different shapes, and a distance between the supporting members can be optimally determined according to the actual audio frequency.

The supporting members may be formed on the porous electrode by transfer printing or decaling, or may be directly formed on the porous electrode by performing a printing technique, such as inkjet printing, direct printing (e.g., screen printing), etc. In another exemplary embodiment, the supporting members may be formed by direct adhesion. For instance, the supporting members are first formed and then disposed between the first and the second metal porous electrodes and the vibrating membrane, and the supporting members can be adhered to or not adhered to the vibrating membrane (or the metal porous electrodes).

In another exemplary embodiment, the supporting members can also be formed by performing an etching process or a photoresist exposure and development process, or a dispensing process.

Some of the exemplary embodiments of the disclosure as well as the drawings are provided below.

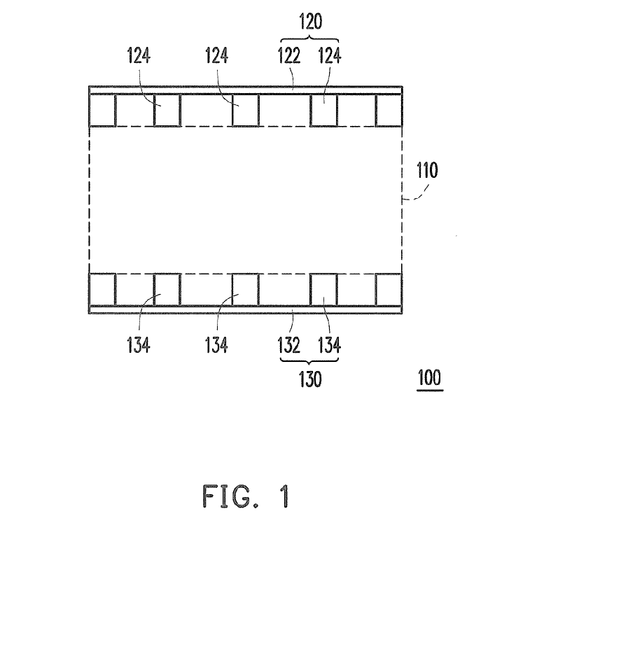

In one of the exemplary embodiments, a flat speaker structure is provided, as shown in FIG. 1. The flat speaker structure 100 at least includes a speaker unit 110, a first vapor-resistant structure 120, and a second vapor-resistant structure 130. The first and second vapor-resistant structures 120 and 130 may be located at two respective sides of the speaker unit 110, in one of the exemplary embodiments. The first vapor-resistant structure 120 includes a first vapor-resistant protection layer 122 and a plurality of first insulation supporting members 124 located between the speaker unit 110 and the first vapor-resistant protection layer 122. The first insulation supporting members 124 are suitable for isolating the first vapor-resistant protection layer 122 from the speaker unit 110. The second vapor-resistant structure 130 includes a second vapor-resistant protection layer 132 and a plurality of second insulation supporting members 134 located between the speaker unit 110 and the second vapor-resistant protection layer 132. The second insulation supporting members 134 are suitable for isolating the second vapor-resistant protection layer 122 from the speaker unit 110.

The first and second vapor-resistant protection layers 122 and 132, for instance, may be made of a cyclic olefin copolymer (COC) thin film or a polymer synthetic resin film sheet, e.g., polypropylene (PP), poly ethylene (PE), polyvinyl chloride (PVC), and urethane, which can serve as a vapor-resistant thin film.

The first and second insulation supporting members 124 and 134 are configured at a region on the speaker unit 110, and the region on the speaker unit 110 does not contain any sound hole. Besides, the first and second insulation supporting members 124 and 134 may have various patterns or different heights based on actual requirements. Additionally, the supporting members can be arranged in a dot-shaped, grid-shaped, or cross-shaped manner, or the supporting members can have other different arrangements.

The speaker unit 110 can have different structures. For instance, in one of the exemplary embodiments, the speaker unit 110 may include two porous electrodes and a vibrating membrane that is located between the two porous electrodes. The vibrating membrane includes an electret material, and further includes a metal film or a conductive material layer formed on the electret material. The thickness of the metal film or the conductive material layer is required not to be greater than the thickness of the layer of the electret material. In another exemplary embodiment, the speaker unit may include a porous electrode layer and a vibrating membrane. The vibrating membrane includes an electret material, and further includes a metal film or a conductive material layer formed on the electret material.

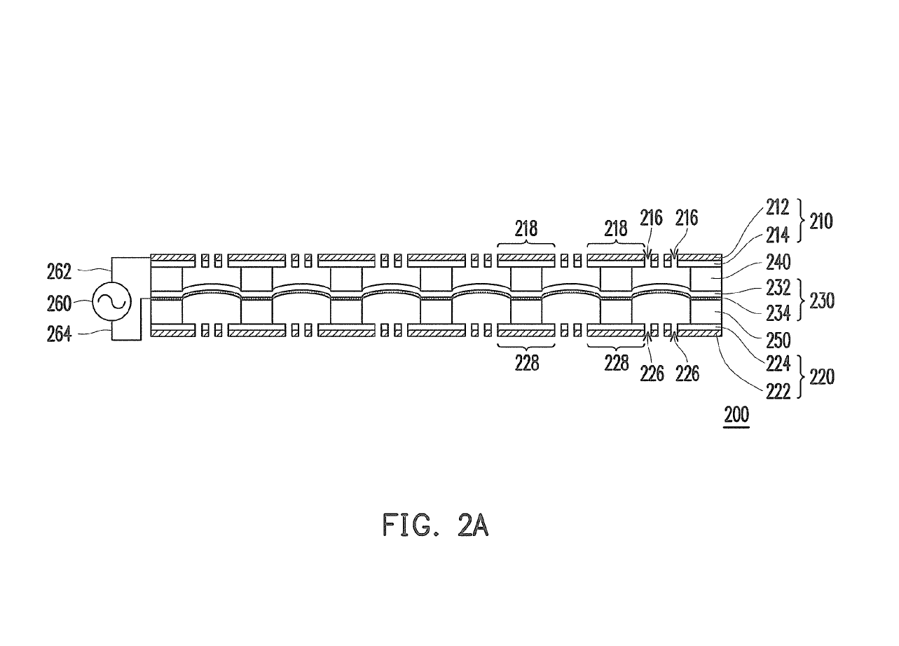

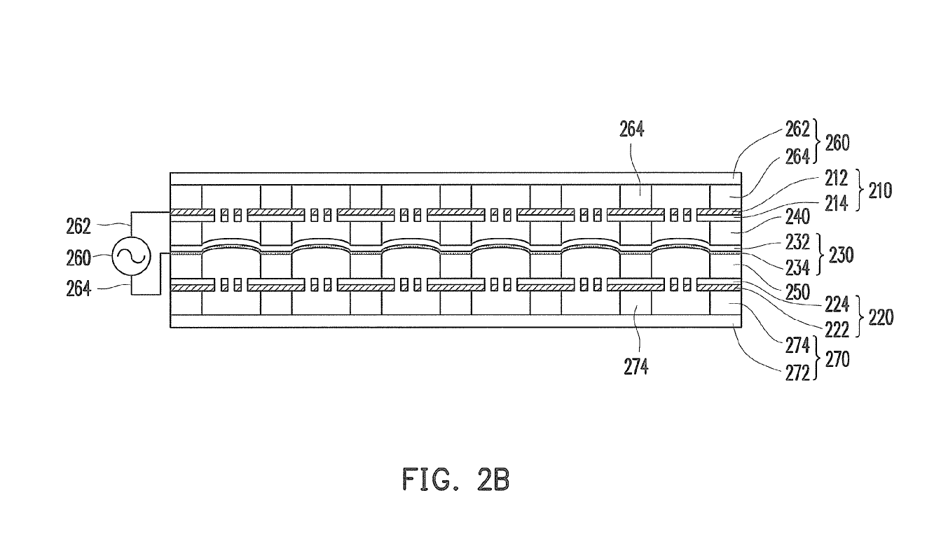

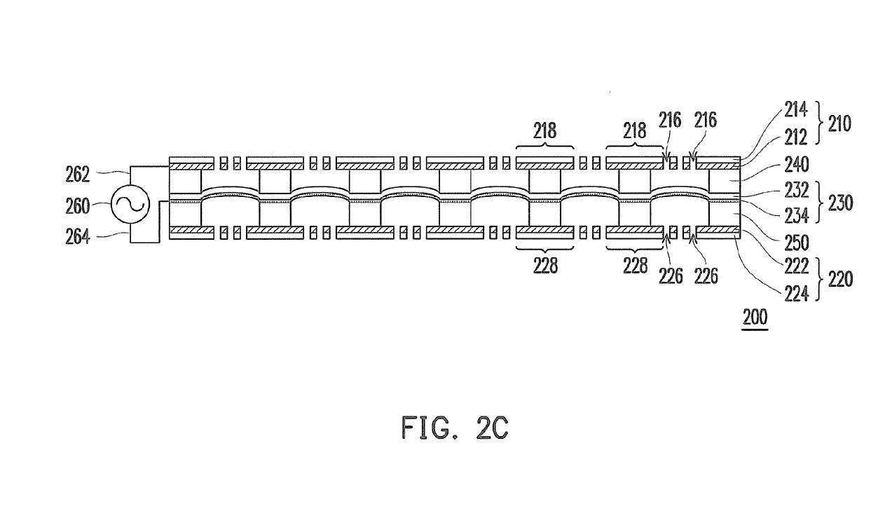

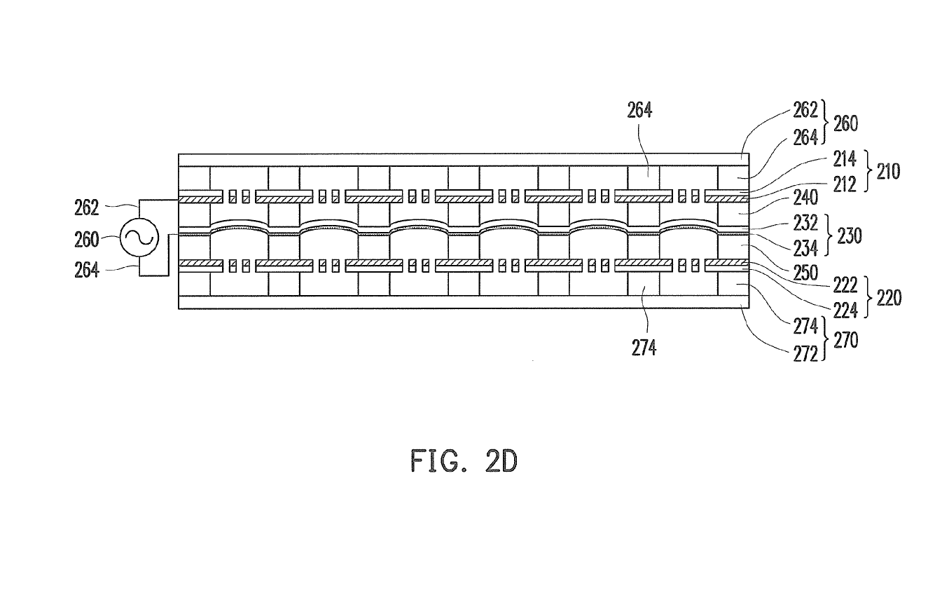

FIG. 2A is a schematic cross-sectional view illustrating a flat speaker unit according to one of the exemplary embodiments of the disclosure. The speaker unit includes a first porous electrode 210, a vibrating membrane 230, and a second porous electrode 220. The first and second porous electrodes 210 and 220 may respectively be a single metal conductive layer, or each of the first and second porous electrodes 210 and 220 may include a porous layer and an electrode layer. In this exemplary embodiment, the first porous electrode 210 includes an electrode layer 212 and a porous layer 214 that faces the vibrating membrane 230. The second porous electrode 220 includes an electrode layer 222 and a porous layer 224 that faces the vibrating membrane 230. The first and second porous electrodes 210 and 220 respectively include a plurality of sound holes 216 and 226.

The vibrating membrane 230 can include a metal film or a conductive material layer and an electrode material. In this exemplary embodiment, the vibrating membrane 230 includes an electret material layer 232 and a metal film 234. The metal film 234 may be formed on the surface of the electret material layer 232 by sputtering or plating.

First supporting members 240 are configured on a region 218 on the first porous electrode 210 and located between the first porous electrode 210 and the vibrating membrane 230. Here, the region 218 is a region on the first porous electrode 210 without any sound hole formed therein. The first supporting members 240 can be designed to have certain patterns based on actual requirements. Second supporting members 250 are configured on a region 228 on the second porous electrode 220 and located between the second porous electrode 220 and the vibrating membrane 230. Here, the region 228 is a region on the second porous electrode 220 without any sound hole formed therein. Besides, the second supporting members 250 can also be designed to have certain patterns based on actual requirements.

FIG. 2B is a schematic cross-sectional view illustrating a flat speaker structure according to one of the exemplary embodiments of the disclosure. In this exemplary embodiment, the flat speaker structure not only includes the speaker unit shown in FIG. 2A but also comprises a first vapor-resistant structure 260 and a second vapor-resistant structure 270 that are located at two respective sides of the speaker unit. The first and second vapor-resistant structures 260 and 270 are located at the outer side of the speaker unit to prevent the environmental vapor from entering the speaker unit, and thereby the reliability of the operation of the speaker unit can be improved.

The first vapor-resistant structure 260 includes a first vapor-resistant protection layer 262 and a plurality of first insulation supporting members 264 located between the first porous electrode 210 and the first vapor-resistant protection layer 262. The first insulation supporting members 264 are located on a region 218 of the first porous electrode 210 for isolating the first vapor-resistant protection layer 262 from the speaker unit 200, such that an air gap exists between the first vapor-resistant protection layer 262 and the speaker unit 200. Here, the region 218 is a region on the first porous electrode 210 without any sound hole formed therein. The second vapor-resistant structure 270 includes a second vapor-resistant protection layer 272 and a plurality of second insulation supporting members 274 located between the second porous electrode 220 and the second vapor-resistant protection layer 272. The second insulation supporting members 274 are located on a region 228 of the second porous electrode 220 for isolating the second vapor-resistant protection layer 272 from the speaker unit 200, such that an air gap exists between the second vapor-resistant protection layer 272 and the speaker unit 200. Here, the region 228 is a region on the second porous electrode 220 without any sound hole formed therein.

In the previous embodiments or other embodiments describing the flat speaker structure, the first and second supporting members 240 and 250 in the speaker unit 200, the first insulation supporting members 264 in the first vapor-resistant structure 260, or the second insulation supporting members 274 in the second vapor-resistant structure 270 can respectively have various patterns or different heights based on actual requirements.

The supporting members can be designed to have different arrangements and heights. When the structure of the supporting members is to be optimally designed, the arrangements and heights of the supporting members may be determined in consideration of audio frequency. The supporting members may be dot-shaped, grid-shaped, cross-shaped, or can have a combination of different shapes, and a distance between the supporting members can be optimally determined according to the actual audio frequency.

The supporting members may be formed on the porous electrode by transfer printing or decaling, or can be directly formed on the porous electrode by performing a printing technique, such as inkjet printing, direct printing (e.g., screen printing), etc. In another exemplary embodiment, the supporting members may be formed by direct adhesion. For instance, the supporting members are first formed and then disposed between the metal porous electrodes and the vibrating membrane, and the supporting members can be adhered to or not adhered to the vibrating membrane (or the porous electrodes). In another exemplary embodiment, the supporting members may also be formed by performing an etching process or a photoresist exposure and development process, or a dispensing process.

FIG. 2C is a schematic cross-sectional view illustrating a flat speaker unit according to another one of the exemplary embodiments of the disclosure. The speaker unit of this embodiment is similar to that depicted in FIG. 2A, while the difference therebetween lies in that the electrode layer 212 of the first porous electrode 210 faces the vibrating membrane 230. The electrode layer 222 of the second porous electrode 220 faces the vibrating membrane 230. FIG. 2D is a schematic cross-sectional view illustrating a flat speaker unit according to another one of the exemplary embodiments of the disclosure. In this exemplary embodiment, the flat speaker structure not only includes the speaker unit shown in FIG. 2C but also comprises a first vapor-resistant structure 260 and a second vapor-resistant structure 270 that are located at two respective sides of the speaker unit.

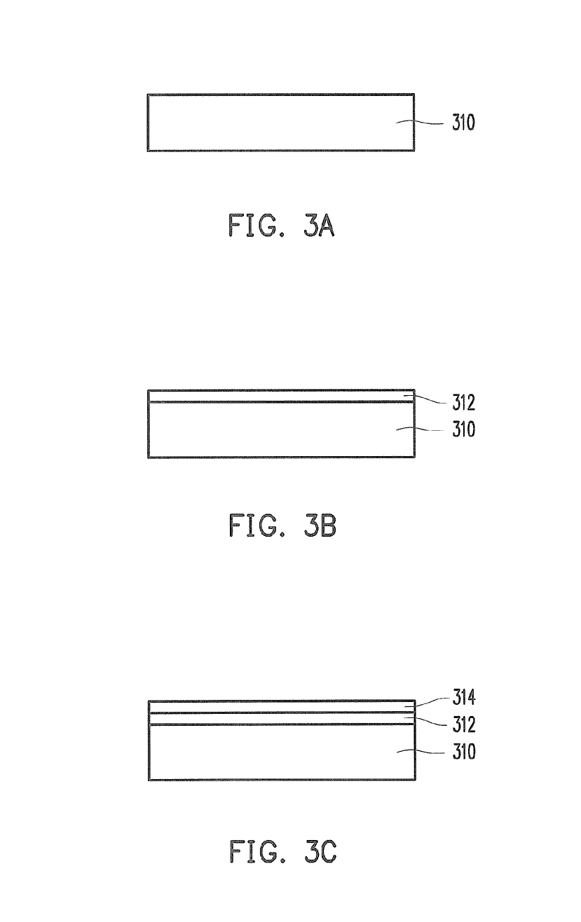

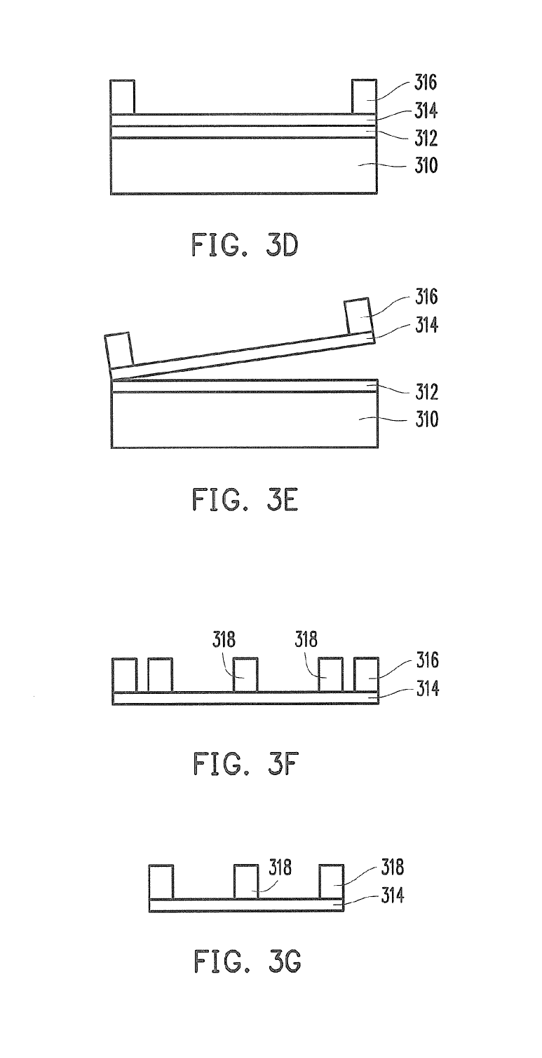

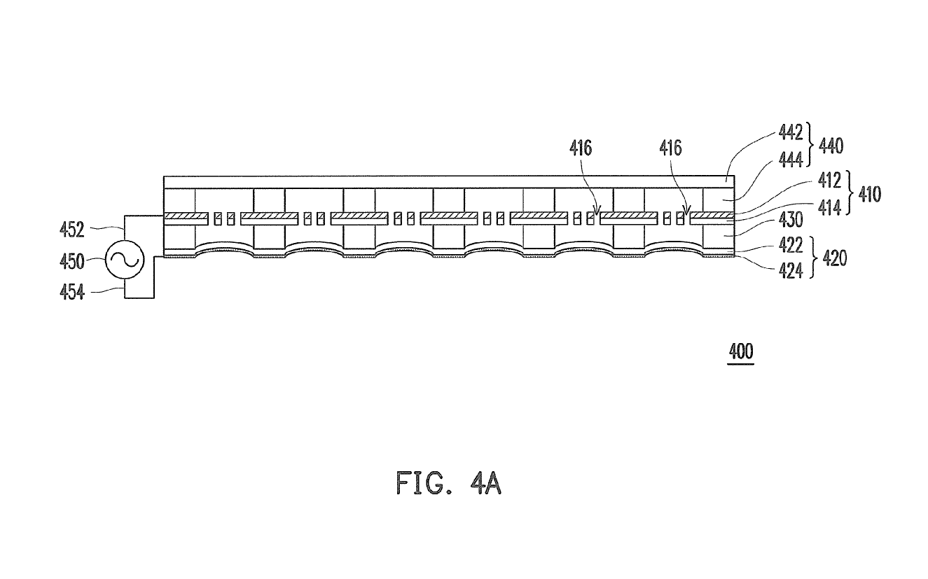

FIG. 3A to FIG. 3G are schematic cross-sectional views illustrating a manufacturing process of a vapor-resistant structure according to an exemplary embodiment of the disclosure. With reference to FIG. 3A, a surface of a substrate 310 is cleaned. With reference to FIG. 3B, a sacrificial layer 312 is formed on the cleaned surface. Here, the sacrificial layer 312 may be formed on the substrate 310 by spinning coating. Besides, the sacrificial layer 312 may be made of a photoresist material on which a baking process is performed at a relatively low temperature (e.g., lower than 100 degrees or even lower than 90 degrees) and a hard baking is not required.

With reference to FIG. 3C, a protection layer 314 is formed above the sacrificial layer 312, and a material of the protection layer 314 is characterized by vapor resistance. For instance, the material of the protection layer 314 includes a COC thin film, a polymer synthesis resin film sheet (e.g., PP, PE, PVC, or urethane). In this embodiment, the protection layer 314 is made of the COC thin film.

With reference to FIG. 3D, a spacer layer 316 is formed above the protection layer 314. The spacer layer 316 is suitable for defining an area occupied by the vapor-resistant structure, such that the supporting members formed in this area can have certain patterns. With reference to FIG. 3E, the protection layer 314 and the spacer layer 316 above the protection layer 314 are peeled off from the sacrificial layer 312. With reference to FIG. 3F, a plurality of supporting members 318 are configured above the protection layer 314 within an area occupied by the spacer layer 316. The supporting members 318 can have certain patterns, heights, or arrangements. With reference to FIG. 3G, the protection layer 314 is cut to remove the spacer layer 316 and a portion of the peripheral protection layer 314, and the vapor-resistant structure that includes the rest of the protection layer 314 and the supporting members 318 thereon is not removed.

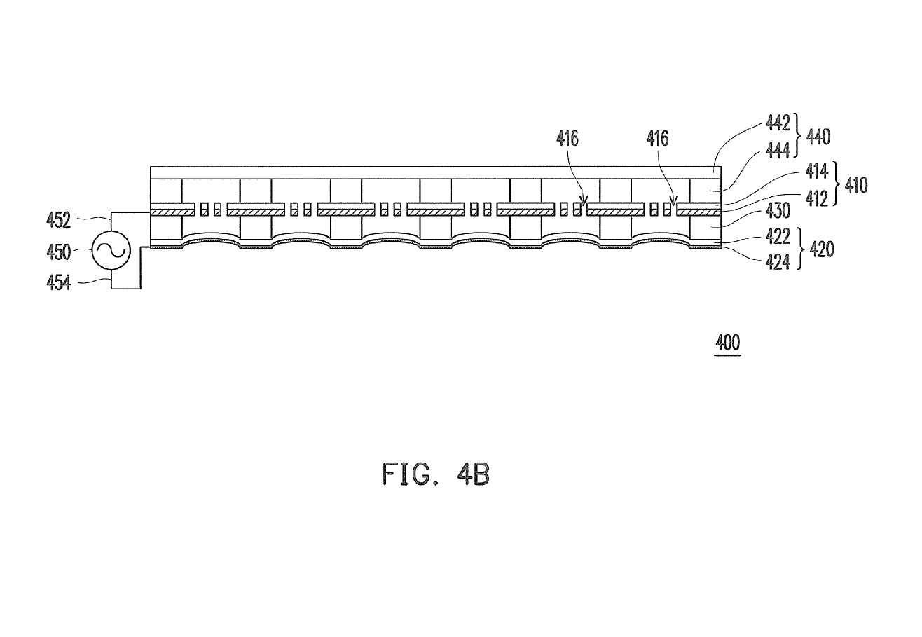

The vapor-resistant structure described in this disclosure can be integrated into not only the speaker unit shown in FIG. 2A but also the speaker unit shown in FIG. 4 to form the flat speaker structure.

FIG. 4A and FIG. 4B are schematic cross-sectional views illustrating a flat speaker unit according to one of the exemplary embodiments of the disclosure.

As indicated in FIG. 4A, the speaker unit 400 includes a porous electrode 410 and a vibrating membrane 420. The porous electrode 410 includes a plurality of sound holes 413. Besides, the porous electrode 410 can be a single metal conductive layer or can include a porous layer and an electrode layer. In this exemplary embodiment, the porous electrode 410 includes an electrode layer 412 and a porous layer 414 that faces the vibrating membrane 420.

When the porous electrode 410 includes the single metal film, the metal film can be made of iron, copper, aluminum, or an alloy thereof. When the porous layer 414 of the porous electrode 410 is an insulation layer, a material of the insulation layer includes plastic, rubber, paper, cotton fiber, and polymer fiber. When the porous layer 414 is a conductive layer, a material of the conductive layer includes aluminum, gold, silver, copper, an alloy thereof, a dual-metal material of Ni/Au, one of ITO and IZO, a combination of ITO and IZO, or a polymer conductive material PEDOT. Further, the conductive layer can also be made of one of metal fiber, oxide metal fiber, cotton fiber, and granite fiber, or a combination thereof.

The porous electrode 410 described in an exemplary embodiment may be made of a transparent material, and the transparent material is selected from the group consisting of ITO, IZO, and aluminum zinc oxide (AZO), or a combination thereof.

The vibrating membrane 420 may include a metal film or a conductive material layer and an electrode material. In this exemplary embodiment, the vibrating membrane 420 includes an electret material layer 422 and a metal film 424. The metal film 424 may be formed on the surface of the electret material layer 422 by sputtering or plating. A plurality of supporting members 430 may be placed on a region of the porous electrode 410 and located between the porous electrode 410 and the vibrating membrane 420. Here, the region on the porous electrode 410 does not have any sound hole, i.e., the sound holes of the porous electrode 410 are not on said region. Besides, the supporting members 430 can be designed to have certain patterns based on actual requirements.

The vapor-resistant structure 440 is located at the outer side of the speaker unit to prevent the environmental vapor from entering the speaker unit, and thereby the reliability of the operation of the speaker unit can be improved. In this exemplary embodiment, the vapor-resistant structure 440 is configured on one side of the porous electrode 410 opposite to the vibrating membrane 420. The vapor-resistant structure 440 includes a vapor-resistant protection layer 442 and a plurality of insulation supporting members 444. The insulation supporting members 444 are located between the vapor-resistant protection layer 442 and the porous electrode 410 of the speaker unit. The insulation supporting members 444 are located on a region on the porous electrode 410 for isolating the vapor-resistant protection layer 442 from the porous electrode 410, such that an air gap exists between the vapor-resistant protection layer 442 and the porous electrode 410. Here, the region on the porous electrode 410 does not have any sound hole, i.e., the sound holes of the porous electrode 410 are not on said region.

FIG. 4B shows another speaker unit 400, and the same elements in FIG. 4B and FIG. 4A are marked by the same reference numbers. The difference between the speaker unit respectively in FIG. 4B and FIG. 4A lies in that the porous electrode 410 in FIG. 4B includes a porous layer 414 and an electrode layer 412 that faces the vibrating membrane 420.

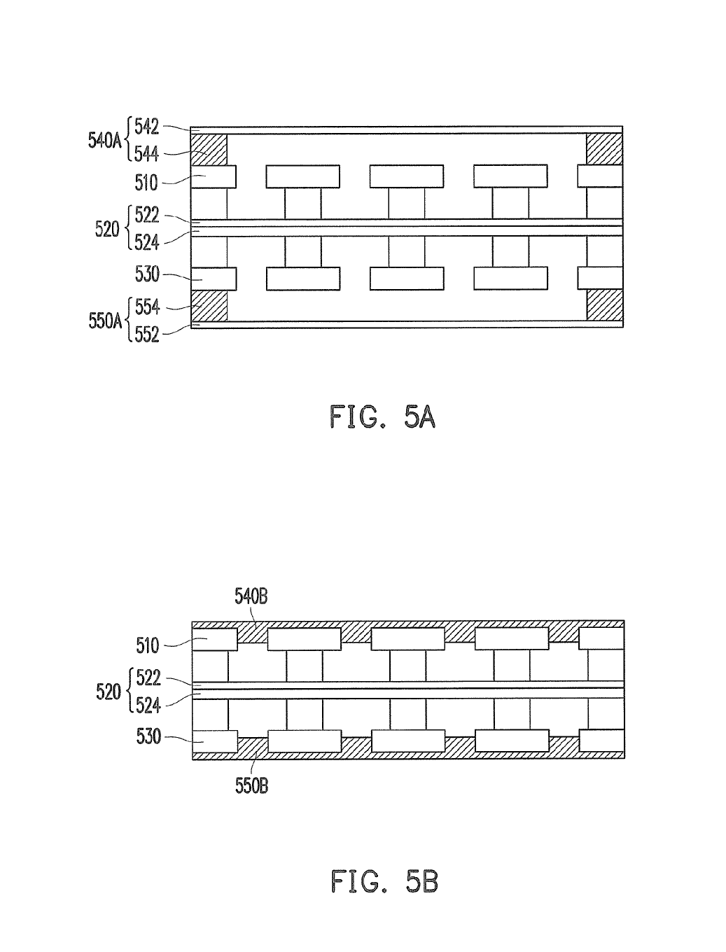

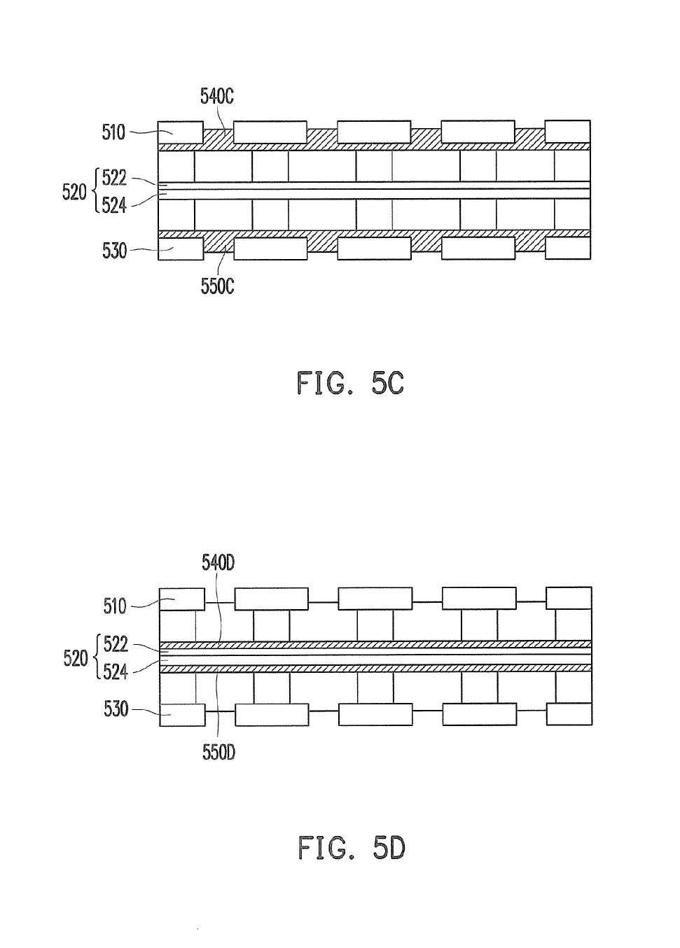

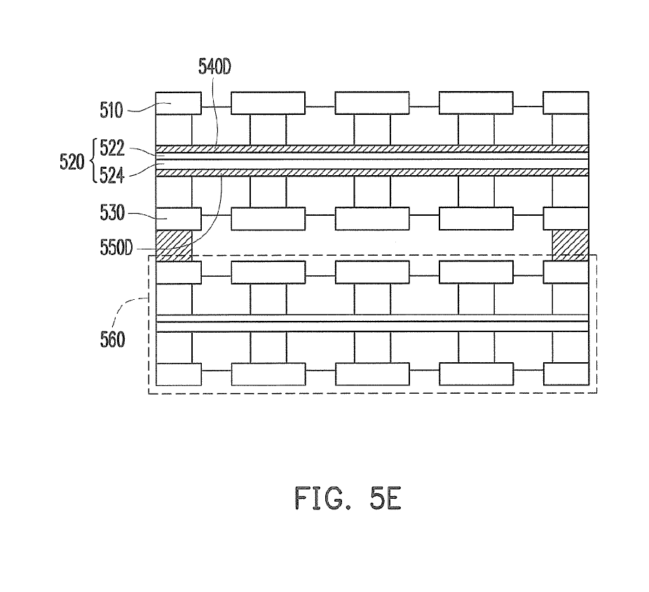

Some of the exemplary embodiments describing the highly reliable flat speaker structure are shown in FIG. 5A to FIG. 5E. The highly reliable flat speaker structure at least includes a vapor-resistant protection layer and a speaker unit. The speaker unit in one of the exemplary embodiments includes a porous electrode and an electret material. The electret material includes a metal film or a conductive material layer and serves as a vibrating membrane. The vapor-resistant protection layer is located at the outer side of the flat speaker structure in some of the embodiments of the disclosure, so as to prevent the environmental vapor from entering the speaker unit and improve the reliability of the operation of the speaker unit, as indicated in FIG. 5A and FIG. 5B. In another embodiment of the disclosure, the vapor-resistant protection layer can also be configured in the speaker unit to block the environment vapor. For instance, as indicated in FIG. 5C, the vapor-resistant protection layer is coated onto the porous electrode; as indicated in FIG. 5D, the vapor-resistant protection layer is formed at the respective sides of the vibrating membrane, and the porous electrode and the supporting members therebetween are configured. Detailed descriptions are provided in the following exemplary embodiments.

With reference to FIG. 5A, in this exemplary embodiment, the flat speaker structure at least includes a speaker unit, a first vapor-resistant structure 540A, and a second vapor-resistant structure 550A. The first and second vapor-resistant structures 540A and 550A are located at two respective sides of the speaker unit. Here, the speaker unit includes two porous electrodes and an electret material therebetween, for instance, which should not be construed as a limitation. If the speaker unit includes multiple stacked layers, the speaker unit still falls within the scope of the embodiments of the disclosure.

The speaker unit includes a first porous electrode 510, a second porous electrode 530, and a vibrating membrane 520 therebetween. The vibrating membrane 520 includes an electret material layer 522 and a metal film 524. Supporting members 570 are configured between the vibrating membrane 520 and the first porous electrode 510 and between the vibrating membrane 520 and the second porous electrode 530.

In this exemplary embodiment, the first vapor-resistant structure 540A includes a first vapor-resistant protection layer 542 and a plurality of first insulation supporting members 544 located between the speaker unit and the first vapor-resistant protection layer 542. The first insulation supporting members 544 are suitable for isolating the first vapor-resistant protection layer 542 from the speaker unit. The second vapor-resistant structure 550A includes a second vapor-resistant protection layer 552 and a plurality of second insulation supporting members 554 located between the speaker unit and the second vapor-resistant protection layer 552. The second insulation supporting members 554 are suitable for isolating the second vapor-resistant protection layer 552 from the speaker unit.

The first and second vapor-resistant protection layers 542 and 552 may be made of a COC thin film or a polymer synthesis resin film sheet (e.g., PP, PE, PVC, and urethane). In another exemplary embodiment, the first and second vapor-resistant protection layers 542 and 552 may be made of metal and plastic that are mixed and melt-blown or blended to form the vapor-resistant protection layers which can serve as vapor-resistant thin films.

The structure shown in FIG. 5B is similar to that shown in FIG. 5A, and thus the same elements in FIG. 5B and FIG. 5A are labeled by the same reference numbers and will not be reiterated. The flat speaker structure in FIG. 5B at least includes a speaker unit, a first vapor-resistant structure 540B, and a second vapor-resistant structure 550B. The first and second vapor-resistant structures 540B and 550B are located at two respective sides of the speaker unit. Besides, the first and second vapor-resistant structures 540B and 550B are respectively made of a vapor-resistant protection material. The first vapor-resistant structure 540B is directly located above the first porous electrode 510 and on the pores of the first porous electrode 510; the second porous electrode 550B is directly located above the second porous electrode 530 and on the pores of the second porous electrode 530.

An evaporation process or a spinning coating process is performed on the vapor-resistant protection material to respectively form the first and second vapor-resistant structures 540B and 550B, for instance. The first and second vapor-resistant structures 540B and 550B are then adhered to an outer side of the porous electrode, such that no vapor-resistant protection material exists between the porous electrodes. In addition, the first and second vapor-resistant structures 540B and 550B are configured on the outer surfaces of the first and second porous electrodes 510 and 530, and thus the vapor-resistant protection material does not enter the pores but is formed on the pore surfaces, as shown in FIG. 5B.

The structure shown in FIG. 5C is similar to that shown in FIG. 5A, and thus the same elements in FIG. 5C and FIG. 5A are labeled by the same reference numbers and will not be reiterated. The flat speaker structure in FIG. 5C at least includes a speaker unit, a first vapor-resistant structure 540C, and a second vapor-resistant structure 550C. The first and second vapor-resistant structures 540C and 550C are located at two respective sides of the speaker unit. Besides, the first and second vapor-resistant structures 540C and 550C are respectively made of a vapor-resistant protection material. The first vapor-resistant structure 540C is directly located between the pores of the first porous electrode 510 and the surface of the first porous electrode 510 facing the vibrating membrane 520; the second vapor-resistant structure 550C is directly located between the pores of the second porous electrode 530 and the surface of the second porous electrode 530 facing the vibrating membrane 520.

The vapor-resistant protection material is directly coated onto the surface of the outer porous electrode facing the vibrating membrane 520 and among the pores by evaporation or spinning coating. That is to say, in an exemplary embodiment, when the outer porous electrode is formed, the first and second vapor-resistant structures 540C and 550C are respectively formed on a surface of the porous electrode by evaporation or spinning coating, and an exemplary adhesion process can be performed to adhere the vapor-resistant protection material to the supporting members, and the vibrating membrane 520 is then assembled to form the flat speaker structure. In this flat speaker structure, the pores of the porous electrode are filled with a portion of the vapor-resistant protection material.

The structure shown in FIG. 5D is similar to that shown in FIG. 5A, and thus the same elements in FIG. 5D and FIG. 5A are labeled by the same reference numbers and will not be reiterated. The flat speaker structure in FIG. 5D at least includes a speaker unit, a first vapor-resistant structure 540D, and a second vapor-resistant structure 550D. Besides, the first and second vapor-resistant structures 540D and 550D are respectively made of a vapor-resistant protection material and are respectively directly configured at two respective sides of the vibrating membrane 520. Given that the speaker includes a plurality of stacked speaker units, the first and second vapor-resistant structures 540D and 550D are respectively located at the two sides of the vibrating membrane of the outer speaker unit, as indicated in FIG. 5E. The first and second vapor-resistant structures 540D and 550D are respectively located at the two sides of the outer speaker unit, and at least one speaker unit 560 is further located below the outer speaker unit.

The vapor-resistant protection material can be directly coated onto the respective sides of the vibrating membrane 520 by evaporation or spinning coating, and an exemplary adhesion process can be performed on the outer porous electrode and the supporting members to form the flat speaker structure. In the highly reliable flat speaker structures shown in FIG. 5A to FIG. 5D, the vapor-resistant material can be the COC thin film or the polymer synthesis resin film sheet (e.g., PP, PE, PVC, urethane, or polyimide). In another exemplary embodiment, the vapor-resistant material can also be metal and may be made of metal and plastic that are mixed and melt-blown or blended.

As described in the embodiments of the invention, the vapor-resistant structure “located at the outer side of the porous electrode” includes the vapor-resistant structure “located at the outermost side of the porous electrode”.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A flat speaker structure comprising:
a vapor-resistant structure; and
a speaker unit comprising a porous electrode and a vibrating membrane, the vibrating membrane comprising a metal film and an electret material,
wherein the vapor-resistant structure is configured at an outer side of the flat speaker structure for preventing vapor from entering the flat speaker structure, the vapor-resistant structure comprises a vapor-resistant protection layer and a plurality of insulation supporting members, and the insulation supporting members are located between the speaker unit and the vapor-resistant protection layer.

2. A flat speaker structure comprising:
a vapor-resistant structure; and
a speaker unit comprising a porous electrode and a vibrating membrane, the vibrating membrane comprising a metal film and an electret material,
wherein the vapor-resistant structure is configured at an outer side of the flat speaker structure for preventing vapor from entering the flat speaker structure, the vapor-resistant structure comprises a vapor-resistant protection layer located on one side of the porous electrode of the speaker unit opposite to the other side of the porous electrode facing the vibrating membrane and also located in a plurality of pores of the porous electrode

3. A flat speaker structure comprising:
a vapor-resistant structure; and
a speaker unit comprising a porous electrode and a vibrating membrane, the vibrating membrane comprising a metal film and an electret material,
wherein the vapor-resistant structure comprises a vapor-resistant protection layer located on one side of the porous electrode of the speaker unit facing the vibrating membrane and also located in a plurality of pores of the porous electrode.

4. A flat speaker structure comprising:
a vapor-resistant structure; and
a speaker unit comprising a porous electrode and a vibrating membrane, the vibrating membrane comprising a metal film and an electret material,
wherein the vapor-resistant structure comprises a first vapor-resistant protection layer and a second vapor-resistant protection layer respectively located on two sides of the vibrating membrane, and one of the two sides faces the porous electrode.

5. The flat speaker structure as recited in claim 1, wherein the insulation supporting members have an arrangement pattern between the speaker unit and the vapor-resistant protection layer, and the arrangement pattern is determined based on arrangement locations of the insulation supporting members.

6. The flat speaker structure as recited in claim 1, wherein the insulation supporting members have an arrangement pattern between the speaker unit and the vapor-resistant protection layer, and the arrangement pattern is determined based on arrangement locations of the insulation supporting members.

7. The flat speaker structure as recited in claim 1, wherein the vapor-resistant protection layer comprises a cyclic olefin copolymer (COC) thin film, polypropylene (PP), poly ethylene (PE), polyvinyl chloride (PVC), urethane, or a combination thereof.

8. The flat speaker structure as recited in claim 1, wherein the porous electrode of the speaker unit is a single metal film having a plurality of pores.

9. The flat speaker structure as recited in claim 1, wherein the porous electrode of the speaker unit comprises a porous layer and an electrode layer, wherein the porous layer is an insulation layer, and the insulation layer is composed of plastic, rubber, paper, cotton fiber, or polymer fiber.

10. The flat speaker structure as recited in claim 1, the porous electrode of the speaker unit comprises a porous layer and an electrode layer, wherein when the porous layer is a conductive layer, and a material of the conductive layer comprises aluminum, gold, silver, copper, an alloy thereof, a dual-metal material of Ni/Au, one of indium tin oxide (ITO) and indium zinc oxide (IZO), a combination of ITO and IZO, or a polymer conductive material PEDOT.

11. The flat speaker structure as recited in claim 1, wherein the electret material is an electret composite material with nano-scale or micro-scale pores.

12. The flat speaker structure as recited in claim 11, wherein the electret composite material with the nano-scale or micro-scale pores is selected from the group consisting of fluorinated hylenepropylene (FEP), polytetrafluoethylene (PTFE), polyvinylidene fluoride (PVDF), a compound having double carbon bonds, and partial fluorine-contained polymer.

13. The flat speaker structure as recited in claim 1, wherein a material of the porous electrode is a flexible and transparent material.

14. The flat speaker structure as recited in claim 13, wherein the material of the porous electrode is selected from the group consisting of polycarbonate (PC), polyethylene terephthalate (PET), cyclic olefin copolymer (COC), and polymethyl methacrylate (PMMA), or a combination thereof.

15. The flat speaker structure as recited in claim 1, wherein a material of the porous electrode comprises a transparent material, and the transparent material is selected from the group consisting of indium tin oxide (ITO), indium zinc oxide (IZO), and aluminum zinc oxide (AZO), or a combination thereof.

16. The flat speaker structure as recited in claim 1, wherein the porous electrode comprises a porous layer and an electrode layer, the porous layer faces the vibrating membrane, and the electrode layer is located toward a sound outgoing direction.

17. The flat speaker structure as recited in claim 1, wherein the porous electrode comprises a porous layer and an electrode layer, the electrode layer faces the vibrating membrane, and the porous layer is located toward a sound outgoing direction.

18. The flat speaker structure as recited in claim 1, wherein the insulation supporting members are configured between the porous electrode and the vibrating membrane.

19. The flat speaker structure as recited in claim 18, wherein the insulation supporting members comprise an arrangement pattern, and the arrangement pattern is configured between the porous electrode and the vibrating membrane and is determined based on an electrostatic effect between the porous electrode and the vibrating membrane.

20. The flat speaker structure as recited in claim 19, wherein the arrangement pattern is determined by shapes or arrangement locations of the insulation supporting members.

21. The flat speaker structure as recited in claim 18, wherein the insulation supporting members are dot-shaped, grid-shaped, cross-shaped, trigonal prism-shaped, cylindrical-shaped, or rectangular-shaped.

22. The flat speaker structure as recited in claim 18, wherein the insulation supporting members are formed by printing, direct printing, laser processing, or cutting and stamping.

23. The flat speaker structure as recited in claim 18, wherein the insulation supporting members are respectively adhered between the porous electrode and the vibrating membrane.

24. A flat speaker structure comprising:
a first vapor-resistant structure;
a second vapor-resistant structure; and
a speaker unit located between the first vapor-resistant structure and the second vapor-resistant structure, the speaker unit at least comprising a first porous electrode, a vibrating membrane, and a second porous electrode, the vibrating membrane comprising a metal film and an electret material and being located between the first and second porous electrodes, wherein the first and second vapor-resistant structures are respectively configured at outer sides of the first and second porous electrodes in the speaker

25. The flat speaker structure as recited in claim 24, wherein the electret material is an electret composite material with nano-scale or micro-scale pores.

26. The flat speaker structure as claimed in claim 25, wherein the electret composite material with the nano-scale or micro-scale pores is selected from the group consisting of fluorinated hylenepropylene (FEP), polytetrafluoethylene (PTFE), polyvinylidene fluoride (PVDF), a compound having double carbon bonds, and partial fluorine-contained polymer.

27. The flat speaker structure as claimed in claim 24, wherein a material of the first and second porous electrodes is a flexible and transparent material.

28. The flat speaker structure as claimed in claim 27, wherein the material of the first and second porous electrodes is selected from the group consisting of polycarbonate (PC), polyethylene terephthalate (PET), cyclic olefin copolymer (COC), and polymethyl methacrylate (PMMA), or a combination thereof.

29. The flat speaker structure as claimed in claim 24, wherein the first and second porous electrodes comprise a transparent material, and the transparent material is selected from the group consisting of indium tin oxide (ITO), indium zinc oxide (IZO), and aluminum zinc oxide (AZO), or a combination thereof.

30. A flat speaker structure comprising:
a first vapor-resistant structure;
a second vapor-resistant structure; and
a speaker unit at least comprising a first porous electrode, a vibrating membrane, and a second porous electrode, the vibrating membrane comprising a metal film and an electret material and being located between the first and second porous electrodes,
wherein the first vapor-resistant structure comprises a first vapor-resistant protection layer, the second vapor-resistant structure comprises a second vapor-resistant protection layer, the first and second vapor-resistant protection layers are respectively located at two sides of the vibrating membrane, and the two sides respectively face the first and second porous electrodes.

31. The flat speaker structure as recited in claim 30, wherein the first and second porous electrodes of the speaker unit respectively comprise a first single metal film and a second single metal film respectively having a plurality of pores.

32. The flat speaker structure as recited in claim 30, wherein the first porous electrode of the speaker unit comprises a first porous layer and a first electrode layer, and the second porous electrode of the speaker unit comprises a second porous layer and a second electrode layer.

33. The flat speaker structure as recited in claim 32, wherein the first and second porous layers are insulation layers or conductive layers.

34. The flat speaker structure as recited in claim 33, wherein when the first and second porous layers are the insulation layers, the insulation layers are composed of plastic, rubber, paper, cotton fiber, or polymer fiber.

35. The flat speaker structure as recited in claim 34, wherein when the first and second porous layers are the conductive layers, the conductive layers comprise aluminum, gold, silver, copper, an alloy thereof, a dual-metal material of Ni/Au, one of indium tin oxide (ITO) and indium zinc oxide (IZO), a combination of ITO and IZO, or a polymer conductive material PEDOT.

36. The flat speaker structure as recited in claim 34, wherein when the first and second porous layers are the conductive layers, the conductive layers comprise metal fiber, oxide metal fiber, carbon fiber, graphite fiber, or a combination thereof.

37. The flat speaker structure as recited in claim 30, wherein the electret material is an electret composite material with nano-scale or micro-scale pores.

38. The flat speaker structure as claimed in claim 30, wherein the first and second porous electrodes comprise a transparent material, and the transparent material is selected from the group consisting of indium tin oxide (ITO), indium zinc oxide (IZO), and aluminum zinc oxide (AZO), or a combination thereof.

39. The flat speaker structure as recited in claim 30, wherein the first porous electrode comprises a first porous layer and a first electrode layer, the second porous electrode comprises a second porous layer and a second electrode layer, the first and second porous layers face the vibrating membrane, and the first and second electrode layers are located toward a sound outgoing direction.

40. The flat speaker structure as recited in claim 30, wherein the first porous electrode comprises a first porous layer and a first electrode layer, the second porous electrode comprises a second porous layer and a second electrode layer, the first and second electrode layers face the vibrating membrane, and the first and second porous layers are located toward a sound outgoing direction.

41. The flat speaker structure as recited in claim 30, wherein a plurality of first and second supporting members are respectively configured between the first and second porous electrodes and the vibrating membrane.

42. The flat speaker structure as recited in claim 41, wherein the first and second supporting members respectively comprise a first and second arrangement patterns, and the first and second arrangement patterns are configured between the first and second porous electrodes and the vibrating membrane and are determined based on an electrostatic effect between the first and second porous electrodes and the vibrating membrane.

43. The flat speaker unit as claimed in claim 41, wherein the first and second supporting members are dot-shaped, grid-shaped, cross-shaped, trigonal prism-shaped, cylindrical-shaped, or rectangular-shaped.

44. The flat speaker structure as recited in claim 41, wherein the first and second supporting members are formed by at least one of printing, direct printing, laser processing, or cutting and stamping.

45. The flat speaker structure as recited in claim 41, wherein the first supporting members are adhered between the first porous electrode and the vibrating membrane, and the second supporting members are adhered between the second porous electrode and the vibrating membrane.

46. A manufacturing method of a vapor-resistant structure suitable for a flat speaker unit, the manufacturing method comprising:
forming a sacrificial layer on a substrate;
forming a protection layer above the sacrificial layer, wherein a material of the protection layer is characterized by vapor resistance;
forming a spacer layer above the protection layer, wherein the spacer layer defines an area occupied by the vapor-resistant structure;
peeling off the protection layer and the spacer layer above the protection layer from the sacrificial layer; and
configuring a plurality of insulation supporting members above the protection layer within an area occupied by the spacer layer, so as to determine a pattern of the insulation supporting members in the area occupied by the spacer layer.

47. The manufacturing method as recited in claim 46, wherein the material of the protection layer comprises a cyclic olefin copolymer (COC) thin film, polypropylene (PP), poly ethylene (PE), polyvinyl chloride (PVC), or urethane.

48. A manufacturing method of a flat speaker unit, the flat speaker unit having a vapor-resistant structure, the manufacturing method comprising:
forming a flat speaker unit, the flat speaker unit at least comprising a porous electrode and a vibrating membrane, the vibrating membrane comprising a metal film and an electret material, the porous electrode having a plurality of pores; and
coating a vapor-resistant material onto the porous electrode of the flat speaker unit by evaporation or spinning coating, so as to form the vapor-resistant structure above the porous electrode and in the pores.
